(19) United States
(12) Patent Application Publication
(10) Pub. No.: US 2024/0354710 A1
(43) Pub. Date: Oct. 24, 2024

(54) METHODS AND SYSTEMS FOR THE CREATION OF PARSERS USING LARGE LANGUAGE MODELS

(71) Applicant: Shopify Inc., Ottawa (CA)

(72) Inventors: Georgios Logiotatidis, Melissia (GR); Dev Tanna, Munich (DE); Dexter Fichuk, Victoria (CA)

(21) Appl. No.: 18/303,921

(22) Filed: Apr. 20, 2023

(51) Int. Cl. G06Q 10/107; G06F 40/205; G06F 40/40

(52) U.S. Cl. CPC G06Q 10/107; G06F 40/205; G06F 40/40

(57) ABSTRACT

A computer system, and a method at a computer system, the method including. receiving a first message at the computing system; determining that a parser for the first message does not exist at the computing system; providing text from the first message and an output template to a large language model; receiving a response from the large language model, the response comprising the output template populated with information from the message; and generating a parser for the message based on the response.

### FIELD OF THE DISCLOSURE

The present disclosure is related to monitoring of electronic messages, and in particular relates to extracting information from electronic messages created using message templates.

### BACKGROUND

Extracted information from messages can be used in a variety of situations. For example, an electronic commerce platform may allow those with accounts on the platform to connect their email accounts. Some or all of the emails arriving at these email accounts can then be monitored by the electronic commerce platform to provide value-added services such as tracking purchases, shipments and deliveries for the account holder.

### SUMMARY

In order to extract the information, an email extractor may be used. An email extractor is an algorithm which is able to extract relevant pieces of information from the content of an email. For example, the email extractor may extract a Tracking Identifier, Order Date, Ship Date, Carrier, and Products, or other information, related to an order from, e.g., a buyer's shipping notification email or an order confirmation email received from a merchant (e.g. with whom they recently placed an order).

High accuracy and precision email extractors are typically trained to parse only one specific email template each. Further, message formats (and/or structure, and/or specific content) may change unpredictably over time.

When parsing a growing stream of emails whose formats and/or structure change unpredictably over time, a solution that will improve scalability (e.g. through automation) would be beneficial.

Large Language Models (LLMs) may in some cases, be used to extract information. In particular, LLMs may be very good at interpreting documents/text/emails (or images thereof or representative thereof, such as ones including QR codes or other such schemes) that were drafted for humans to read or otherwise consume. However, LLMs may require significant processing power, may be costly, and/or may be resource intensive.

Fast and straightforward XPATH-based parsers are good at processing email of known structure, but generally fail to work when coming across new unknown email structures (or new variations of a known email structure that deviate too much from the known structure). Such XPATH-based parsers are further not straightforward to create, and the creation of such parsers takes time and resources.

Therefore, the embodiments of the present disclosure may use LLMs to create parsers when a particular email or cluster of emails does not have a parser available, or to validate a parser for a particular cluster.

In one aspect, a method at a computing system is provided. The method may include receiving a first message at the computing system and determining that a parser for the first message does not exist at the computing system. The method may further include providing text from the first message and an output template to a large language model and receiving a response from the large language model, the response comprising the output template populated with information from the message. The method may further include generating a parser for the message based on the response.

In some embodiments, the text may contain the information in an unstructured format.

In some embodiments, the response may contain the information in a structured format.

In some embodiments the structured format may conform to the rules of a markup language.

In some embodiments the method may further, prior to creating the parser, validate the response against the first message.

In some embodiments the validating may comprise checking values received in the response against the first message.

In some embodiments the method may further comprise: applying a mapping function to the received message to create a characteristic value, wherein the mapping function is adapted to map similar messages to similar characteristic values; and grouping the first message with other messages having the similar characteristic values; wherein the determining may further comprise finding that the first message has been grouped with a threshold number of other messages.

In some embodiments, the first message may comprise a message within an electronic commerce system, and wherein the information comprises at least one of a tracking identifier, an order date, a ship date, a carrier, and a product information.

In some embodiments the generating the new parser may comprise determining XPATHs in the received message for the information in the response from the large language model.

In some embodiments, the generated parser may be used to extract information from a subsequent message having a message template that is similar to a message template for the first message.

In a further aspect, a computer system comprising a processor and a communications subsystem may be provided. The computer system may be configured to receive a first message at the computing system and determine that a parser for the first message does not exist at the computing system. The computer system may further be configured to provide text from the first message and an output template to a large language model and receive a response from the large language model, the response comprising the output template populated with information from the message. The computer system may further be configured to generate a parser for the message based on the response.

In some embodiments the text may contain the information in an unstructured format.

In some embodiments, the response may contain the information in a structured format.

In some embodiments, the structured format may conform to the rules of a markup language.

In some embodiments the computer system may further be configured to, prior to creating the parser, validate the response against the first message.

In some embodiments computer system may be configured to validate by checking values received in the response against the first message.

In some embodiments the computer system may further be configured to: apply a mapping function to the received message to create a characteristic value, wherein the mapping function may be adapted to map similar messages to similar characteristic values; and group the first message with other messages having the similar characteristic values; wherein the computer system may be configured to determine by finding that the first message has been grouped with a threshold number of other messages.

In some embodiments the first message may comprise a message within an electronic commerce system, and wherein the information comprises at least one of a tracking identifier, an order date, a ship date, a carrier, and a product information.

In some embodiments the computer system may be configured to generate the new parser comprises determining XPATHs in the received message for the information in the response from the large language model.

In some embodiments, the generated parser may be used to extract information from a subsequent message having a message template that is similar to a message template for the first message.

In a further aspect, a non-transitory computer readable medium for storing instruction code may be provided. The instruction code, when executed by a processor of a computer system, may cause the computer system to receive a first message at the computing system and determine that a parser for the first message does not exist at the computing system. The instructions code may further cause the compute system to provide text from the first message and an output template to a large language model and receive a response from the large language model, the response comprising the output template populated with information from the message. The instruction code may further cause the computer system to generate a parser for the message based on the response.

### BRIEF DESCRIPTION OF THE DRAWINGS

The present disclosure will be better understood with reference to the drawings, in which:

FIG. 1A is a block diagram of a simplified convolutional neural network, which may be used in examples of the present disclosure.

FIG. 1B is a block diagram of a simplified transformer neural network, which may be used in examples of the present disclosure.

FIG. 2 is a block diagram of an example computing system, which may be used to implement examples of the present disclosure.

FIG. 3 is a block diagram showing an example e-commerce system capable of implementing the embodiments of the present disclosure.

FIG. 4 is a block diagram showing an example interface for a merchant using the e-commerce platform of FIG. 3.

FIG. 5 is a block diagram showing a first example message created from a template with information embedded therein.

FIG. 6 is a block diagram showing a second example message created from a template with information embedded therein.

FIG. 7 is a process diagram showing a process for assigning a value to a cluster.

FIG. 8 is a process diagram showing the use of an LLM in the generation of a parser for message information.

FIG. 9 is a process diagram showing the use of an LLM in the validation of results from a parser for message information.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

In accordance with various embodiments of the present disclosure, a system is provided in which a Large Language Model can be used to assist in the creation of parsers.

In particular, a computer system such as an e-commerce platform, may monitor a user's email box or other messaging system for particular types of messages. Such messages are typically computer generated and form part of the e-commerce transaction, and can include messages that an order has been placed, that an order has been shipped, that the order has been delivered, among other options. Typically, such message is formed utilizing a template. The e-commerce platform may include message extractors for known templates or groups of templates, where the message extractor can successfully extract information from such messages.

When a template changes (e.g., when a particular sender changes the template they are using for sending some or all of their messages), such as if a merchant tweaks or completely changes the layout of an email such as an Order Confirmation email, a new message extractor may need to be used to extract information from a message utilizing such new template. In other cases, the container for the template may completely change, such as a merchant moving from email notification to Short Message Service (SMS) notifications. Further, in some cases the SMS notifications may have their own template.

However, an e-commerce platform serving thousands of vendors may have thousands or hundreds of thousands of message extractors based on known templates and therefore, an appropriate extractor may be hard to identify or may not exist. A consequence of this may be that the system is no longer able to extract content from any of the Order Confirmation emails it receives that use the merchant's new template. Furthermore, it is possible that none of the existing email extractors may be effective at extracting information from the new email template, and therefore a new extractor may be needed. In the meantime, buyers are no longer able to receive updates about this commerce activity.

Systems and methods are provided below for identifying situations in which a parser does not exist for a message template, and using an LLM during parser creation.

### Machine Learning and Computing Device

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publically-available text corpuses may be, e.g., fine-tuned by further training using the complete works of Shakespeare as training data samples (e.g., where the intended use of the ML model is generating a scene of a play or other textual content in the style of Shakespeare).

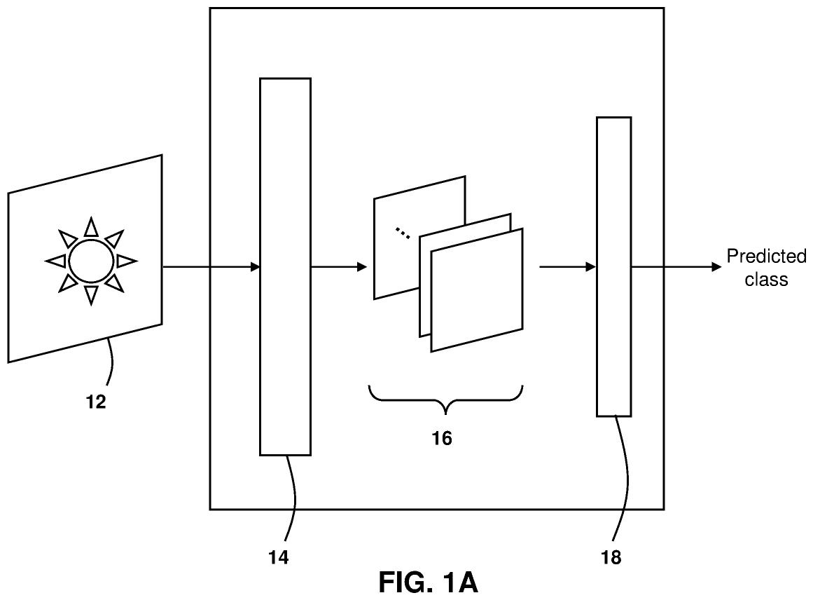

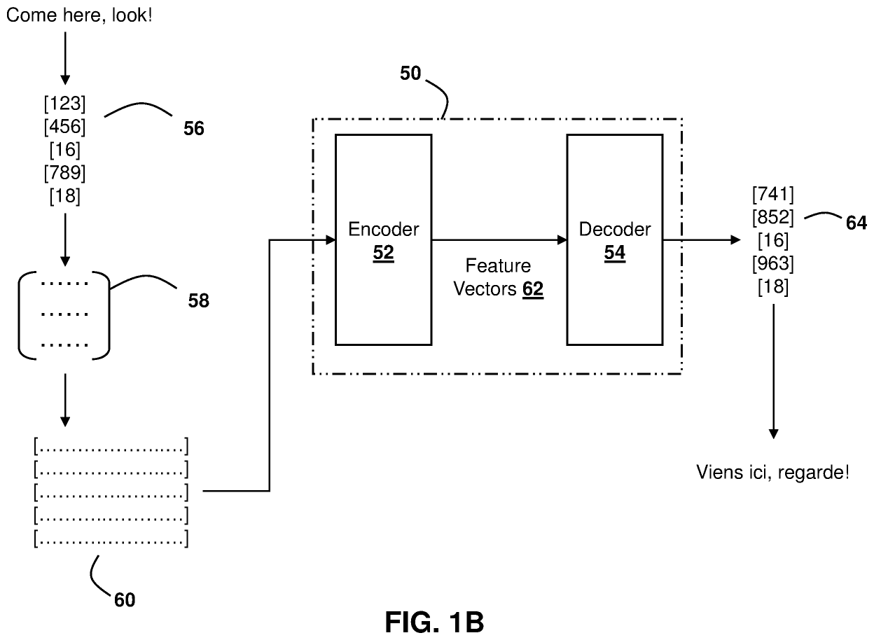

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

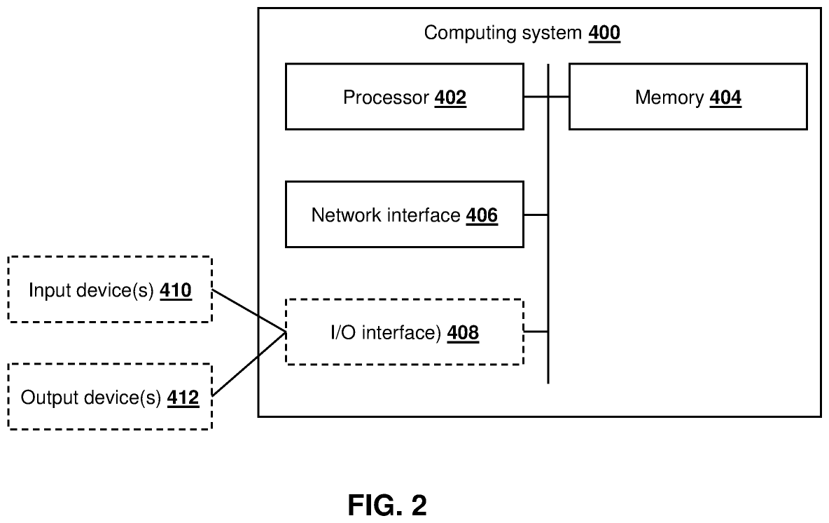

FIG. 2 illustrates an example computing system 400, which may be used to implement examples of the present disclosure, such as a prompt generation engine to generate prompts to be provided as input to a language model such as a LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

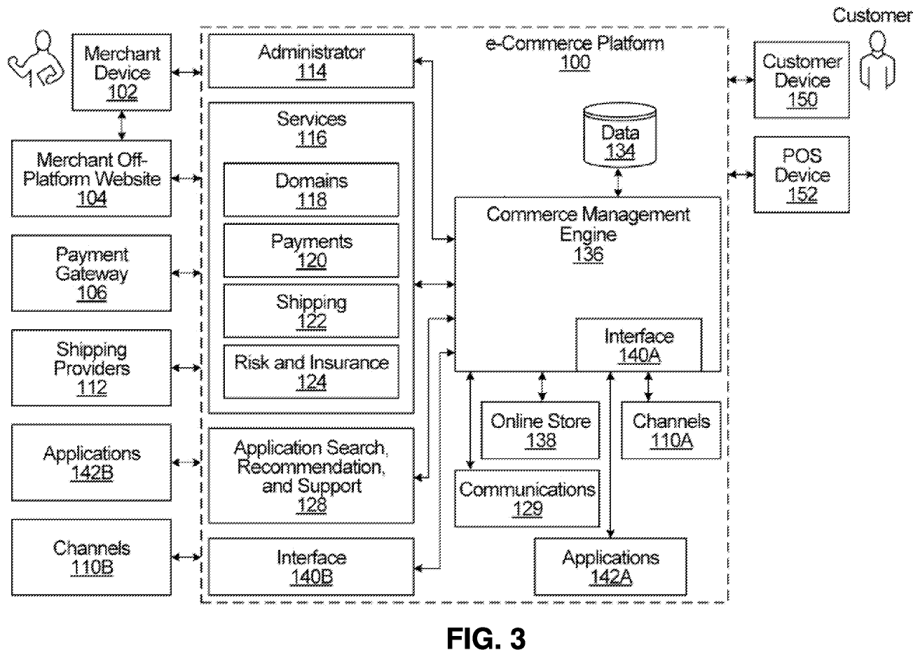

FIG. 3 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 3, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (Saas), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

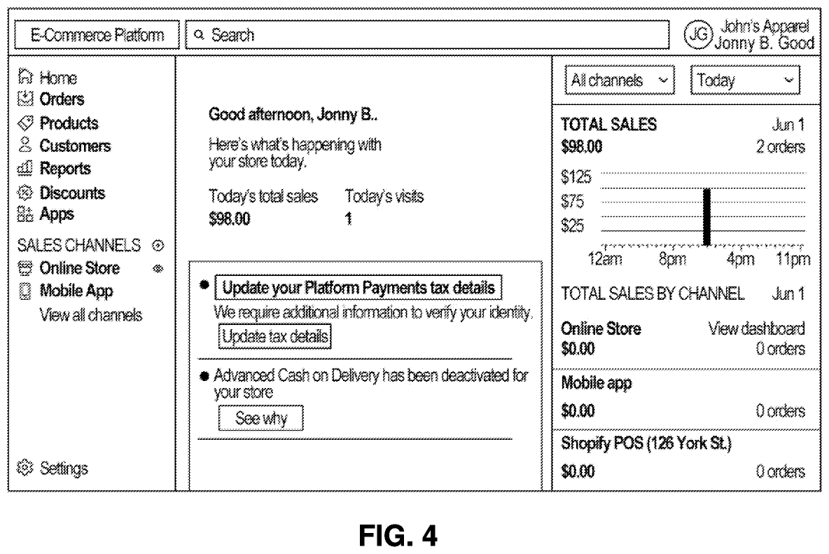

FIG. 4 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 4. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 3, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Message Templates

As provided above, an electronic commerce platform such as that described with regards to FIG. 3, may allow those with accounts on the platform to connect their messaging accounts. Messaging accounts may include email accounts, text message accounts, or any other type of account in which a merchant may send messages to a customer. The present disclosure is described with regards to email accounts for illustration. However, this is not limiting, and the same principles could be applied to other types of messaging accounts.

Some or all of the messages arriving at these email accounts can then be monitored by the electronic commerce platform to provide value-added services such as tracking purchases, shipments and deliveries for the account holder.

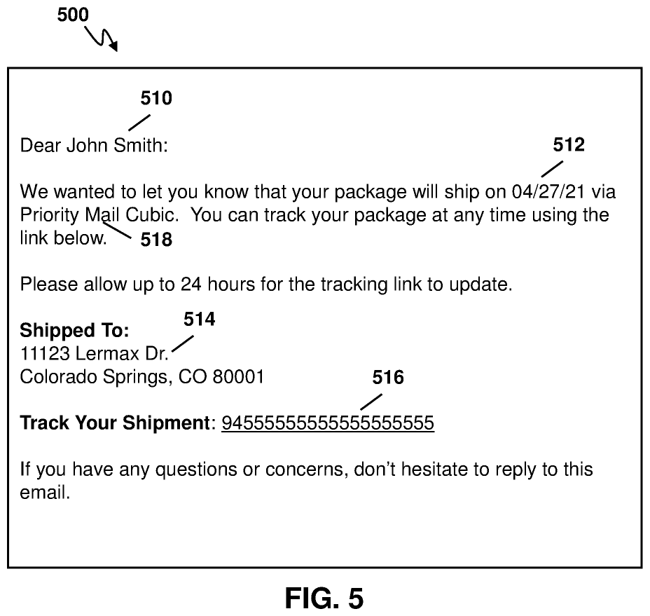

Typically, such messages will be computer generated using a template. A template is indicative of a structure or layout of a message. For example, reference is made to FIG. 5.

In the example of FIG. 5, a message 500 may be received by an account holder of an e-commerce platform. The account holder has subscribed to the e-commerce platform to monitor transactions and in this regard, the message 500 may be analyzed by the e-commerce platform.

Message 500 is from a vendor who uses a first template. In particular, message 500 is a shipping notification to indicate that a product has shipped or will soon ship. Various fields within the message are filled in by the computer generating the message and the remainder of the template remains the same between messages. For example, the template for message 500 includes a name field 510, a shipping date 512, an address shipped to block 514, as well as a URL for the shipping number shown with URL 516 for a shipper 518.

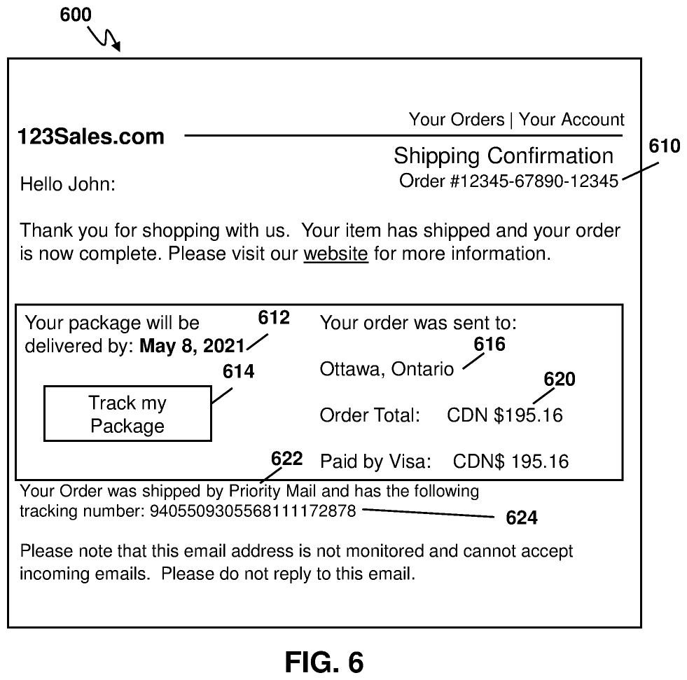

Referring to FIG. 6, another example email received by an account holder for the e-commerce platform is provided. In the example of FIG. 6, a message 600 is again a shipping notification indicating that an order has been shipped. Message 600 is from a different vendor and uses a different template than that of FIG. 5, and has various fields such as an order number 610, a delivery date 612, a block or button 614 having a unique URL behind such button, a shipping destination 616, an order price 620, a shipper 622, and a tracking number 624.

When comparing the embodiments of the templates shown in FIGS. 5 and 6, the structure of the templates is completely different. Each email has a unique layout, HyperText Markup Language (HTML) and/or extensible Markup Language (XML) structure, and has different XML Paths (XPath). In particular, an XPath is a syntax or language for finding any element in an XML document using the XML path expression.

Further, while the embodiments of FIGS. 5 and 6 show shipping notifications, other messages from a vendor may include an order confirmation message, an order processed notification, a delivery pending shortly notification, a delivery notification, among others. Each may have a different template assigned thereto.

Further, vendors may use different notification templates depending on other factors such as country or region of a customer, a type of product or service involved with a particular transaction, based on the recipient of the message, among other options. For example, if the product is being shipped to a customer in Canada the notification message may be in both English and French, whereas a notification to a customer in the United States may be in English only, or in English and Spanish in some cases. If the customer is a member of a loyalty program the template used may include fields and wording around loyalty rewards for the transaction. Other factors are possible. Each may therefore use a different template.

The structure of a template may be used for assigning templates into groups, called clusters, and assigning a value to such cluster.

### Clusters and Cluster Values

In some cases, the same templates may be used by different vendors. For example, when a vendor is part of an e-commerce platform, the e-commerce platform may provide, as part of its service, various templates that the vendor may use for notifications from their storefront. In other cases, related companies may use the same notification templates. Other options for the reuse of templates are also possible.

In this regard, the templates may be assigned into a logical group referred to herein as a cluster. A group of emails utilizing the same template may be grouped or categorized into such cluster, and one or more email extractors as defined below may be assigned to such cluster.

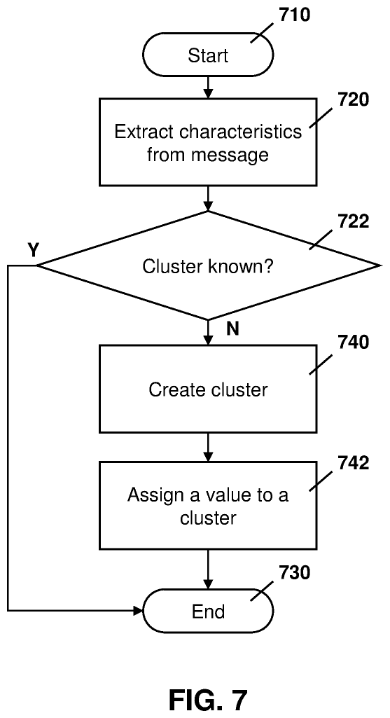

Each cluster may have a value assigned thereto. Specifically, reference is made to FIG. 7, which shows a process for assigning a value to a cluster.

The process of FIG. 7 starts at block 710 and proceeds to block 720 in which characteristics (e.g. a characteristic value) are extracted from a message.

Based on the characteristics extracted at block 720, a check can be made at block 722 to determine whether a cluster is known for the message characteristics. This may, for example, be done with a mapping function. If yes, the process proceeds to block 730 and ends. If the characteristic value for the message is similar to a value for a cluster, then the message may be grouped in that cluster.

Conversely, if a cluster is not known then the process proceeds to block 740 in which a cluster may be created. The process then proceeds to block 742 in which a value is assigned to the cluster. The value may be assigned in various ways.

In one embodiment, the value may be a hash of the elements in a template. For example, utilizing the template for the message of FIG. 5, the XPaths of the email template are:

TABLE 1
Example XPaths for an Email Template

```
[
  ‘/html’,
  ‘/html/body’,
  ‘/html/body/font’,
  ‘/html/body/font/br[1]’,
  ‘/html/body/font/br[2]’,
  ‘/html/body/font/br[3]’,
  ‘/html/body/font/br[4]’,
  ‘/html/body/font/br[5]’,
  ‘/html/body/font/br[6]’,
  ‘/html/body/font/b[1]’,
  ‘/html/body/font/br[7]’,
  ‘/html/body/font/br[8]’,
  ‘/html/body/font/br[9]’,
  ‘/html/body/font/br[10]’,
  ‘/html/body/font/b[2]’,
  ‘/html/body/font/a’,
  ‘/html/body/font/br[11]’,
  ‘/html/body/font/br[12]’
]
```

In one embodiment, the value for the cluster may therefore be based on a minhash of the XPaths for the primary email template used for that cluster. A minhash is an algorithm for estimating how similar two sets are and may in some cases produce a fixed length array of values for a given input. For example, the XPaths in Table 1 can be used in a minhash function where the output is defined to have a fixed sized array of values, for example 128 values. This is however not limiting and other lengths are possible. The output of such minhash function may be:

TABLE 2
Example minhash of XPaths of Table 1

[4138275, 58467968, 361694150, 60789464, 245961614, 7841238,
90464114, 57044459, 354535158, 194189851, 140056852, 60798928,
194284999, 45838352, 151698913, 36481736, 27197609, 332341639,
70279226, 349082816, 185879925, 186146414, 89945648, 276059490,
38312470, 133999309, 23856165, 277015002, 572091941, 92895461,
80811224, 214262812, 545873223, 9395008, 10930505, 227986709,
20629749, 31596960, 466741011, 51216863, 551949416, 295030646,
677315696, 42131191, 107637808, 63825010, 246814026, 49316811,
325148032, 213424747, 249791222, 29511745, 69035818, 28622995,
512800234, 139457788, 313654355, 36857204, 55603873, 275578986,
363485812, 153524886, 123565663, 61487864, 13420203, 28292728,
14478851, 64900169, 7373373, 425451853, 294656222, 6716086,
320325391, 495924302, 407123249, 363237260, 189620341, 243627538,
133233712, 165993244, 543186247, 189101443, 366586677, 242145588,
53910115, 220089639, 47608692, 279398352, 465508506, 120219978,
606245647, 448302536, 250528084, 920785849, 156799164, 131690695,
381496397, 181417001, 137386063, 223089022, 616125108, 278446605,
797038136, 163450663, 72773915, 460478840, 34887879, 15320297,
2666089, 21835911, 9738635, 82448666, 421678353, 129315830,
24403591, 900464338, 103312975, 159061420, 198902214, 144899528,
77265193, 221203133, 2817520, 74641430, 144255143, 102180984,
73413794, 137281749]

The array of Table 2 may therefore be the value assigned at block 742 to the cluster containing the template for the email message of FIG. 5.

The use of a minhash to calculate the value at block 542 is however merely an example. In other cases, values could be generated using other techniques. For example, an encoder using a natural language processing machine learning (ML) model could be used. Such encoder may be trained on millions of raw emails to gain its own understandings of emails and structures. Such encoder could assign a value to the cluster, and subsequently a cosine similarity could be used to match a value for an incoming email to a centroid.

In other cases, other value assigning processes could be used.

Once the value is assigned at block 742 the process proceeds to block 730 and ends.

The process of FIG. 7 could, for example, be used whenever a new cluster is created. If a value needs to be assigned to more than one cluster in a system, the process of FIG. 7 could be repeated for each cluster.

### Message Parser

A message parser is an algorithm, code segment or program that is used to find information from a message. The message parser may be customized or programmed specifically for a template to allow the program to quickly and accurately find the information elements desired by a computer system such as an e-commerce platform. The terms message parser and message extractor may be used interchangeably for the embodiments of the present disclosure.

The information elements extracted by an email (or other message) parser could be configured based on the type of message being received and the type of information within that message. Further, certain information may be relevant for the e-commerce platform or computer system while other information may be irrelevant, and therefore the message parser may be customized to obtain only the relevant information in some cases.

Utilizing the example message from FIG. 5, one simplified message parser is illustrated with regard to Table 3.

TABLE 3
Example of a simplified message parser

```
{
  “tracking_number”: “xpath[/html/body/font/a/text( )]”,
  “carrier”: null,
  “tracking_url”: “xpath[/html/body/font/a/@href]”
}
```

As seen in the example of Table 3, the information sought from the message of FIG. 5 by a computer system such as an e-commerce platform includes the tracking number, and tracking URL. The location of these elements is provided as an XPath within the message. However, this is merely an example and the identification of the information desired within a message template could be done in other ways, such as relative positions, based on tags within the message, among other options.

Further, in the example of Table 3, information about a carrier may also be desired by an e-commerce platform. However, in this case the message does not include such information and therefore the value is assigned as a null value in accordance with the example of Table 3. In other cases, information that is not available may simply be ignored by the message parser. Other options are possible.

Based on the simplified message extractor of Table 3, the information extracted from the message of FIG. 5 is provided in Table 4 below.

TABLE 4
Information from the message extractor of Table 3

```
{
  “carrier”: null,
  “tracking_number”: “94555555555555555555 ”,
  “tracking_url”:
“https://tools.usps.com/go/
TrackConfirmAction.action?tLabels=94555555555555555555 ”
}
```

While the example extractor of Table 3 and results of Table 4 provide for the tracking number and tracking URL. In other examples the computer system or e-commerce platform may desire to check a shipping address against a registered shipping address for a client and therefore may extract the shipping address 514 from message 500. In other cases, the date 512 may be extracted. In some cases, more sophisticated algorithms may be applied to the data and more or fewer data fields may need to be extracted. Therefore, the example of Table 3 is provided merely for illustration purposes.

As seen from the example of Table 3, the message parser is a program that can be run quickly on messages as they are received at the system and the message extractor is tailored to the template by utilizing the positions of the information within the message for extraction. This ensures that computing resources are utilized efficiently when processing thousands or hundreds of thousands of messages in a short time period.

For this reason, high accuracy and precision email or message parsers are typically trained to parse only one specific email template each. Therefore, a sophisticated email extracting system, such as one built to interpret e-commerce emails from buyers' inboxes, may require thousands or hundreds of thousands of email extractors, each trained to identify specific relevant information from a single distinct email template.

When an email template changes, such as if a merchant tweaks or completely changes the layout of an email such as an Order Confirmation email, an appropriate extractor or parser may be hard to identify or may not exist. The consequence of this is that the system is no longer able to extract content from any of the Order Confirmation emails it receives that use the merchant's new template. Furthermore, it is possible that none of the existing email parsers may even be effective at extracting information from the new email template, therefore a new parser may be needed.

Specifically, each cluster may be assigned a parser. Additionally or alternatively, a cluster may be assigned more than one parser (and, e.g., the parsers may be used together with a procedure for resolving conflicting results between them on messages associated with the cluster). Typically, such parser (or extractor) is created manually and can therefore be time consuming to create. The parser is used to retrieve values within the message that may be of interest to the system. Specifically, email messages are, in many cases, auto-generated using templates, and such templates will map to similar identifiers. For example, as provided above, an email extractor may extract a Tracking Identifier, Order Date, Ship Date, Carrier, and Products, or other information, related to an order from a buyer's shipping notification email received from a merchant with whom they recently placed an order. The email parser may use XPATHs, or other hardcoded or stored locations, within the message to find the information in some cases. However other options are possible.

One method for finding matching extractors for a cluster is provided in, for example, US Pat Pub No 2023/0030234, the contents of which are hereby incorporated by reference.

When an incoming email is entered into the extracting system, the system identifies a relevant parser to assign to it. In one case, this is done by using a clustering algorithm to identify and cluster distinct groups of emails together. For example, store ABC Order Confirmation cluster, store ABC Shipping Update cluster. The groups of emails in these clusters may be across multiple email senders who use the same or similar templates, and the clusters are not necessarily tagged explicitly.

In other cases, all or a subset of existing parsers in the system could be run against the message. When a message cannot be parsed by a parser, the parsing will fail and the process could move on to the next parser. Therefore, in some cases no clustering may occur.

In still further cases, a combination of clustering and running all or a subset of parsers could be done. For example, messages that are not able to be parsed by a number of top parsers may thereafter be clustered.

Other options are possible.

However, with the above techniques of clustering to find a parser, or by running through all or a subset of parsers, in some cases a parser still may not be found.

In accordance with the embodiments of the present disclosure, systems and methods are provided to facilitate the creation of parsers using large language models.

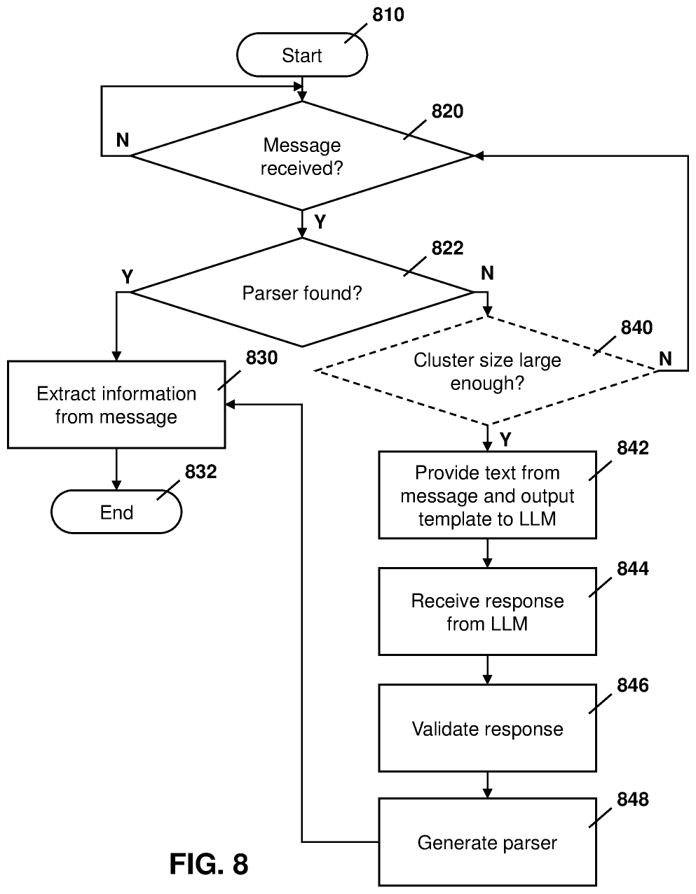

Specifically, reference is now made to FIG. 8. The process of FIG. 8 starts at block 810 and proceeds to block 820 to check whether a message has been received by the system.

If no message has been received, the process proceeds back to block 820 to continue to wait for a message to be received.

Once a message is received, the process proceeds from block 820 to block 822 in which a check is made to determine whether a parser can be found for the message. As indicated above, this could be based on finding a characteristic value of the message and finding whether such characteristic value is within a threshold of a cluster value.

In some cases, the determination of whether a parser can be found comprises checking through all or a subset of existing parsers, and finding whether information extraction was possible with such existing parsers. In some cases this may involve only looking at a portion of the message before determining that the parser cannot parse the information in the message before moving to the next parser.

Other options for finding whether a parser exists for particular message or message fragment are also possible, and the present disclosure is not limited to any particular process for the determination of whether a parser exists for a particular message.

If a parser exists, the process proceeds from block 822 to block 830 in which information may be extracted from the message. For example, using the message of FIG. 5, the tracking number, date, address another similar information could be extracted from the message. Such information may be used, for example, in providing value added services to a customer or subscriber to track purchases, shipping and delivery, among other options.

From block 830, the process proceeds to block 832 and ends.

Conversely, if a parser is not found at block 822, the process may optionally proceed to block 840 in which a check is made to determine whether a cluster size is large enough to proceed with the provision of message information to a large language model. In particular, as indicated above, LLMs are slow and computer resource expensive. Thus, in some cases, the provision of information to the LLM may only be done when a cluster size reaches a threshold. By limiting the use of the LLM to create parsers or validate parsers, the resource can be effectively utilized. Specifically, the resource may be effectively utilized because the parser that is being created can be used for similar emails that are deemed to be common enough within the system.

If a cluster size threshold is used at block 840, and the cluster size is not large enough, then the process proceeds back to block 820 to wait for a new message to be received.

As indicated above, the check for the cluster size at block 840 is optional. The providing of the message to the LLM may be done for each message without a parser in some cases. In some cases, only when a cluster size reaches a threshold will the message be provided to the LLM. In some cases, more than one message from a cluster can be provided to the LLM to have multiple results for building parsers.

Therefore, in some cases the process may proceed from block 822 directly to block 842. Further, if a cluster size check is used at block 840, then if the cluster size is large enough the process may proceed from block 840 to block 842.

At block 842, various prompts can be provided to the LLM. These include the message, which in some cases may be plain text stripped of various html, image, or other elements (e.g. such plain text generated using a library capable of parsing HTML and returning plain text, such as the BeautifulSoup Python library), along with a template, such as a JSON like structure with all the information desired to be extracted from emails.

Thus, the plain text from the message may be in an unstructured data format, and may be provided to the LLM along with a JSON-like template. For example, the prompt may be structured so as to include a JSON-like structure with placeholders in a manner similar to that found in Table 5 below:

TABLE 5
Prompt Structure for LLM query

```
[plain text of the email]
---
{
  “order number”: “XXX”,
  “order placed date”: “XXX”,
  “store name”: “XXX”,
  “store url”: “XXX”,
  “final total amount with currency”: “XXX”,
  “tracking information”: [{
    “tracking number”: “XXX”,
    “carrier”: “XXX”,
    “tracking url”: “XXX”,
    “estimated delivery date”: “XXX”,
  }],
  “products”: [
    {
      “product name”: “XXX”,
      “quantity”: “XXX”,
      “final unit price with currency”: “XXX”,
      “final subtotal with currency”: “XXX”,
      “size”: “XXX”,
      “color”: “XXX”,
    }]
  }
—
Use only information from the first paragraph to replace XXX in the
python dictionary.
```

From the example prompt structure of Table 5, a prompt having such a structure instructs the model to extract multiple trackers and multiple products, when available. It makes it clear that only information “from the first paragraph” (i.e. the plain text) must be used to replace “XXX”, an instruction which, along with temperature set to zero, returns deterministic replies. Without this strict guidance, the model may try to satisfy the request to the maximum and will come up with values that do not exist in the plain text.

The use of plain text from a message, rather than the message with complete hypertext markup language (HTML), may be used in some cases due to prompt size limitations. For example, using an LLM such as the OpenAI GPT-3 or ChatGPT model, limitations are imposed on the prompt size. The message in HTML can easily exceed these limits.

However, in some cases, some or all of the HTML may be provided to the model.

Further, in some cases the plain text may consist of only a message fragment or portion of the message.

Table 6 provides an example prompt that may be sent to the model at block 842.

TABLE 6
Example prompt for an LLM query

Your item(s) have shipped View in browser Hi Lena! 1 item has shipped. SHIPPING
CONFIRMATION Order # 100100100 Placed on 12/2/22 All items from this order
have shipped. TRACK PACKAGE This email is your receipt • Bring this email to make
a return in store • Or return by mail • Your package may not include a paper invoice Hi
Lena! 1 item has shipped. SHIPPING CONFIRMATION Order # 100100100 Placed
on 12/2/22 All items from this order have shipped. TRACK PACKAGE This email is
your receipt • Bring this email to make a return in store • Or return by mail • Your
package may not include a paper invoice PACKAGE (1 item) Soft-Brushed Oversized
Blazer for Women Color: Herringbone Size: XL Price: CA$61.00 Qty: 1 CA$61.00
Canada UPS tracking number: 1ZR6A92520508045 Shipping to: Foo Bar 100 Boing
boing, NS B2W 4B5 Package total: CA$46.35 MASTER ending in 5282 SUMMARY
OF CHARGES FOR PACKAGE Package #1ZR6A92520508045 Package Subtotal (1
item) CA$69.00 Promotions -CA$28.70 Shipping CA$0.00 Tax CA$6.05 Package
Total CA$46.35 MASTER ending in 5282 HELPFUL INFORMATION • Return items in
store by showing the cashier this email. Eligible items can also be returned by mail .
Visit our Returns Help page for more details. • See FAQs on our Customer Service
page. • Customer Support available 7am - 1am EST. 1-800-ABC-CORP ( 1-800-555-
1234 ) RETURN BARCODE For in-store returns RMA: 00003 - 794 - 8070 -
20221203 - 6020 This email is your receipt • Bring this email to make a return in store
• Or return by mail • Your package may not include a paper invoice PACKAGE (1
item) Soft-Brushed Oversized Blazer for Women Color: Herringbone Size: XL Price:
CA$61.00 Qty: 1 CA$61.00 Canada UPS tracking number: 1ZR6A92520508045
Shipping to: Foo Bar 100 Boing boing, NS B2W 4B5 Package total: CA$46.35
MASTER ending in 5282 SUMMARY OF CHARGES FOR PACKAGE Package
#1ZR6A92520508045 Package Subtotal (1 item) CA$69.00 Promotions -CA$28.70
Shipping CA$0.00 Tax CA$6.05 Package Total CA$46.35 MASTER ending in 5282
HELPFUL INFORMATION • Return items in store by showing the cashier this email.
Eligible items can also be returned by mail . Visit our Returns Help page for more
details. • See FAQs on our Customer Service page. • Customer Support available
7am - 1am EST. 1-800-ABC-CORP ( 1-800-555-1234 ) RETURN BARCODE For in-
store returns RMA: 00003 - 794 - 8070 - 20221203 - 6020 This email is your receipt •
Bring this email to make a return in store • Or return by mail • Your package may not
include a paper invoice Privacy Policy | Language Preference This email contains
information regarding your transaction at ABC Corp. You can unsubscribe from
marketing emails by clicking “ Unsubscribe .” You will continue to receive
transactional and account-related emails. Please see our Rewards Program Terms
for details on how to manage your membership. If you have any questions, contact
ABC Corp\u2019s Customer Service Page or call us at 1-800-ABC-CORP (1-800-
555-1234). You may also contact us by postal mail at ABC Corp Customer Services,
5432 Any Street North, Brampton, ON, L6X 1C6, Canada. © 2022 ABC Inc.
---
{ “order number”: “XXX”, “order placed date”: “XXX”, “store name”: “XXX”, “final total
amount with currency”: “XXX”, “tracking information”: [{ “tracking number”: “XXX”,
“carrier”: “XXX”, “tracking url”: “XXX”, “estimated delivery date”: “XXX”, }], “products”:
[ { “product name”: “XXX”, “quantity”: “XXX”, “final unit price with currency”: “XXX”,
“final subtotal with currency”: “XXX”, “size”: “XXX”, “color”: “XXX”, }] }
—
Use only information from the first paragraph to replace XXX in the JSON structure
above.

Therefore, at block 842, a prompt may be provided to an LLM in the format of Table 5, as for example provided in Table 6.

The process may then proceed to block 844 in which a response may be received from the LLM. For example, a response to the prompt of Table 6 is shown in Table 7 below.

TABLE 7
Example LLM response

{ “order number”: “100100100”, “order placed date”: “12/2/22”, “store name”: “ABC
Corp”, “final total amount with currency”: “CA$46.35”, “tracking information”: [{
“tracking number”: “1ZR6A92520508045”, “carrier”: “UPS”, “tracking url”:
“www.ups.com”, “estimated delivery date”: “TBD”, }], “products”: [ { “product name”:
“Soft-Brushed Oversized Blazer for Women”, “quantity”: “1”, “final unit price with
currency”: “CA$61.00”, “final subtotal with currency”: “CA$69.00”, “size”: “XL”, “color”:
“Herringbone”, }] }

Based on Table 7, a structured format (e.g. a JSON like structure) is received as a response from the LLM.

In practice it was found that requesting more information from the model resulted in higher quality answers. Specifically, the prompt of Table 6 requests information that may not be needed for parsers, such as product color and line item subtotals. However, having two different amount requests (i.e. “final total amount with currency” and “final subtotal with currency”) may drive the model to try and find two answers instead of just settling with the first price-like value the model locates in the text. Similarly item characteristics like color and size may help with better identification of all items, while at the same time avoiding upsells of other products listed in the email, which usually don't have as much information.

The process then proceeds from block 844 to block 846 in which the response may be validated.

In particular, in some embodiments the model may occasionally return “N/A” for fields it cannot find information for, while other times it will not return those fields. Also sometimes it returns invalid JSON, for example by using single quotes instead of doubles. Both problems are easy to overcome with preprocessing of the reply.

Further, validation at block 846 may consist of comparing the results received from the LLM with the original message. Specifically, if the information provided back from the LLM does not exist in the original message, then the LLM may have made-up the information. This is sometimes referred to as hallucination, which is when the AI model provides a confident response that does not seem to be justified by, e.g., the input data. In natural language processing, for example, a hallucination may be defined as “generated content that is nonsensical or unfaithful to the provided source content”.

For example, the LLM may have tried to conform to an expected form of a response, especially where the input of the LLM did not include one or more instructions to avoid outputting made-up information or information that the LLM could not otherwise substitute based on, for example, its training data, its inputs, data from outgoing session of prompts and responses involved involving the LLM, among other options.

Therefore, the validating at block 846 may check whether a tracking number received in the response from the LLM exists within the message provided to the LLM. The returned tracking number may be useless if it was made up rather than being extracted from the email itself.

Similarly, other data provided in the response from the LLM at block 844 may be compared with the text provided to the LLM in block 842 to ensure that the data was not created by the AI model.

If data in the response does not exist in the original message, in some cases the response may be discarded and the process might end. In other cases, only parts of the response that are able to be validated are used.

In other cases, if the cluster size is greater than one, then results from two messages provided to the LLM that come from the same cluster may be compared during the validation at block 846 to ensure that the data came from the same part of the message.

During validation, the response from the LLM may also be used to identify spam or marketing messages, and discard those messages. This may be used to provide an indication that certain clusters containing such messages do not need to be parsed. The validation of the LLM response may further be used to flag that something is off with a message and escalate that message to be processed by a human.

Other validation may further be performed.

The validated LLM response from block 846 can then be used to create a parser at block 848 by finding the information returned by the LLM within the message to map the XPATHS. Thus the results from the LLM may be used to create a parser rather than merely finding information in the email.

In particular, an application or library for parsing the HTML and extensible Markup Language (XML) may in some cases be used. One example may include the use of the BeautifulSoup Python library, which when provided with the original message and regular expressions can be used to locate elements in the HTML part of the email, based on the model's reply. This allows accurate identification of the XPath of a value.

However, other options for mapping the reply to the XPath are possible.

Further, in some cases the model may provide valid answers that span different HTML elements. For example, the complete product name may be split into two elements, one acting as title and the other as subtitle. For such cases, one option is to do an exhaustive search and locate partial matches. The process may then use a Levenshtein distance metric to pick the best matching candidate.

Some fields may be challenging to locate in the HTML document accurately. Quantity is one of them and the reason is that it is usually “1” and the number one is very likely to be found in different places of the HTML document. For emails with multiple products, in one embodiment the process at block 848 may identify the product root and narrow the search to only items below it.

With single product emails an advanced regex and a scoring mechanism may be used identify the best candidate. In this case, further validation may be used to ensure the correct field is captured.

For images and links a different approach may be used. Since only the plain text may be provided at block 842 to the model, the model may not have the required context to reply with product image URLs or order links. In this case, XPath may be used locality to identify images close to product names and URLs that wrap order and tracking numbers. Other options are possible.

The XPath mapper may provide the results in Table 8 below based on the message received that was used to create the prompt of Table 6:

TABLE 8
Reply of XPath Mapper

```
{
  “order number”: {
    “calculated_value”: “100100100”,
“xpath”:
“/html/body/table/tr/td/table/tr[2]/td/table/tr[5]/td/div/table/tr[2]/td/table/tr/td[2]/table/tr/td[
2]/table/tr[3]/td/table/tr/td[2]/table/tr[3]/td/a”,
    “text”: “Order # 100100100”,
    “normalized_xpath”: “xpath[normalize-space(substring-after(normalize-
space(/html/body/table/tr/td/table/tr[2]/td/table/tr[5]/td/div/table/tr[2]/td/table/tr/td[2]/tabl
e/tr/td[2]/table/tr[3]/td/table/tr/td[2]/table/tr[3]/td/a/text( )), ‘# ’))]”,
    “normalized_text”: “100100100”
  },
  “order placed date”: {
    “calculated_value”: “12/2/22”,
    “xpath”:
“/html/body/table/tr/td/table/tr[2]/td/table/tr[5]/td/div/table/tr[2]/td/table/tr/td[2]/table/tr/td[
2]/table/tr[3]/td/table/tr/td[2]/table/tr[5]/td”,
    “text”: “Placed on 12/2/22”
    “normalized_xpath”: “xpath[normalize-space(substring-after(normalize-
space(/html/body/table/tr/td/table/tr[2]/td/table/tr[5]/td/div/table/tr[2]/td/table/tr/td[2]/tabl
e/tr/td[2]/table/tr[3]/td/table/tr/td[2]/table/tr[5]/td/text( )), ‘on ’))]”,
    “normalized_text”: “12/2/22”
  },
  “store name”: {
    “calculated_value”: “ABC Corp”,
    “xpath”: “.”,
    “text”: “ABC Corp”,
    “normalized_xpath”: “value[ABC Corp]”,
    “normalized_text”: “ABC Corp”
  },
  “final total amount with currency”: {
    “calculated_value”: “CA$46.35”,
    “xpath”:
“/html/body/table/tr/td/table/tr[2]/td/table/tr[7]/td/div/table/tr[9]/td/table/tr/td[2]/table/tr[9]/
td/table/tr/td[2]/b”,
    “text”: “CA$46.35”,
    “normalized_xpath”: “xpath[normalize-
space(/html/body/table/tr/td/table/tr[2]/td/table/tr[7]/td/div/table/tr[9]/td/table/tr/td[2]/tabl
e/tr[9]/td/table/tr/td[2]/b/text( ))]”,
    “normalized_text”: “CA$46.35”
  },
  “tracking information”: [
    {
      “tracking number”: {
        “calculated_value”: “1ZR6A92520508045”,
        “xpath”:
“/html/body/table/tr/td/table/tr[2]/td/table/tr[7]/td/div/table/tr[5]/td/table/tr/td[2]/table/tr[1]/
td/table/tr/td[3]/table/tr[3]”,
        “text”: “\n1ZR6A92520508045\n”,
        “normalized_xpath”: “xpath[normalize-
space(string(/html/body/table/tr/td/table/tr[2]/td/table/tr[7]/td/div/table/tr[5]/td/table/tr/td[
2]/table/tr[1]/td/table/tr/td[3]/table/tr[3]))]”,
        “normalized_text”: “1ZR6A92520508045”
      },
      “carrier”: {
        “calculated_value”: “UPS”,
        “xpath”:
“/html/body/table/tr/td/table/tr[2]/td/table/tr[7]/td/div/table/tr[5]/td/table/tr/td[2]/table/tr[1]/
td/table/tr/td[3]/table/tr[1]/td”,
        “text”: “Canada UPS tracking number:”,
        “normalized_xpath”: “xpath[normalize-space(substring-before(substring-
after(normalize-
space(/html/body/table/tr/td/table/tr[2]/td/table/tr[7]/td/div/table/tr[5]/td/table/tr/td[2]/tabl
e/tr[1]/td/table/tr/td[3]/table/tr[1]/td/text( )), ‘Canada ’), ‘ tracking’))]”,
        “normalized_text”: “UPS”
      },
      “tracking url”: {
        “calculated_value”: “www.ups.com”,
        “xpath”: “”,
        “text”: “”,
        “normalized_xpath”: “”,
        “normalized_text”: “”
      },
      “estimated delivery date”: {
        “calculated_value”: “TBD”,
        “xpath”: “”,
        “text”: “”,
        “normalized_xpath”: “”,
        “normalized_text”: “”
      }
    }
  ],
  “products”: [
    {
      “product name”: {
        “calculated_value”: “Soft-Brushed Oversized Blazer for Women”,
        “xpath”:
“/html/body/table/tr/td/table/tr[2]/td/table/tr[7]/td/div/table/tr[2]/td/table/tr/td[2]/table/tr[3]/
td/table/tr/td[3]/table/tr[1]/td/b”,
        “text”: “Soft-Brushed Oversized Blazer for Women”,
        “normalized_xpath”: “xpath[normalize-
space(/html/body/table/tr/td/table/tr[2]/td/table/tr[7]/td/div/table/tr[2]/td/table/tr/td[2]/tabl
e/tr[3]/td/table/tr/td[3]/table/tr[1]/td/b/text( ))]”,
        “normalized_text”: “Soft-Brushed Oversized Blazer for Women”
      },
      “quantity”: {
        “calculated_value”: “1”,
        “xpath”:
“/html/body/table/tr/td/table/tr[2]/td/table/tr[7]/td/div/table/tr[2]/td/table/tr/td[2]/table/tr[3]/
td/table/tr/td[3]/table/tr[2]/td/table/tr[4]/td[3]/table/tr/td[1]”,
        “text”: “1”,
        “normalized_xpath”: “xpath[normalize-
space(/html/body/table/tr/td/table/tr[2]/td/table/tr[7]/td/div/table/tr[2]/td/table/tr/td[2]/tabl
e/tr[3]/td/table/tr/td[3]/table/tr[2]/td/table/tr[4]/td[3]/table/tr/td[1]/text( ))]”,
        “normalized_text”: “1”
      },
      “final unit price with currency”: {
        “value”: “CA$61.00”
      },
      “final subtotal with currency”: {
        “calculated_value”: “CA$69.00”,
        “xpath”:
“/html/body/table/tr/td/table/tr[2]/td/table/tr[7]/td/div/table/tr[9]/td/table/tr/td[2]/table/tr[5]/
td/table/tr[1]/td[2]”,
        “text”: “CA$69.00”,
        “normalized_xpath”: “xpath[normalize-
space(/html/body/table/tr/td/table/tr[2]/td/table/tr[7]/td/div/table/tr[9]/td/table/tr/td[2]/tabl
e/tr[5]/td/table/tr[1]/td[2]/text( ))]”,
        “normalized_text”: “CA$69.00”
      },
      “size”: {
        “value”: “XL”
      },
      “color”: {
        “value”: “Herringbone”
      },
      “image”: {
        “calculated_value”: null,
        “xpath”:
“/html/body/table/tr/td/table/tr[2]/td/table/tr[7]/td/div/table/tr[2]/td/table/tr/td[2]/table/tr[3]/
td/table/tr/td[3]/table/tr[2]/td/table/tr[1]/td[2]/img/@src”,
        “text”: “https://image.email.athleta.com/lib/fe9f13707564037d77/m/19/eb25f9ef-
1d9a-414a-821e-5ed40e2c57bf.gif”,
        “normalized_xpath”:
“xpath[/html/body/table/tr/td/table/tr[2]/td/table/tr[7]/td/div/table/tr[2]/td/table/tr/td[2]/tabl
e/tr[3]/td/table/tr/td[3]/table/tr[2]/td/table/tr[1]/td[2]/img/@src]”,
        “normalized_text”:
“https://image.email.athleta.com/lib/fe9f13707564037d77/m/19/eb25f9ef-1d9a-414a-
821e-5ed40e2c57bf.gif”
      }
    }
  ],
  “order url”: {
    “calculated_value”: null,
    “xpath”:
“/html/body/table/tr/td/table/tr[2]/td/table/tr[5]/td/div/table/tr[2]/td/table/tr/td[2]/table/tr/td[
2]/table/tr[3]/td/table/tr/td[2]/table/tr[3]/td/a/@href”,
    “text”:
“https://click.email.abccorp.ca/?qs=aa0a0a0000000aa00aaa00aaa00aa00000aaa000
a000a0000a0a00a00a00a000000a0aaa0a000a000000aaa0000a00a00a00a0000a00
a0a00a000a00a0a0aaa0”,
    “normalized_xpath”:
“xpath[/html/body/table/tr/td/table/tr[2]/td/table/tr[5]/td/div/table/tr[2]/td/table/tr/td[2]/tabl
e/tr/td[2]/table/tr[3]/td/table/tr/td[2]/table/tr[3]/td/a/@href]”,
    “normalized_text”:
“https://click.email.abccorp.ca/?qs=aa0a0a0000000aa00aaa00aaa00aa00000aaa000
a000a0000a0a00a00a00a000000a0aaa0a000a000000aaa0000a00a00a00a0000a00
a0a00a000a00a0a0aaa0”
  }
}
```

The reply can be generalized to the parser of Table 9.

TABLE 9
Parser

```
{
  “order_number”: “xpath[normalize-space(substring-after(normalize-
space(/html/body/table/tr/td/table/tr[2]/td/table/tr[5]/td/div/table/tr[2]/td/table/tr/td[2]/tabl
e/tr/td[2]/table/tr[3]/td/table/tr/td[2]/table/tr[3]/td/a/text( )), ‘# ’))]”,
  “order_url”:
“xpath[/html/body/table/tr/td/table/tr[2]/td/table/tr[5]/td/div/table/tr[2]/td/table/tr/td[2]/tabl
e/tr/td[2]/table/tr[3]/td/table/tr/td[2]/table/tr[3]/td/a/@href]”,
  “seller”: “value[ABC Corp]”,
    “broker”: “value[ABC Corp]”,
“created_at”: “xpath[normalize-space(substring-after(normalize-
space(/html/body/table/tr/td/table/tr[2]/td/table/tr[5]/td/div/table/tr[2]/td/table/tr/td[2]/tabl
e/tr/td[2]/table/tr[3]/td/table/tr/td[2]/table/tr[5]/td/text( )), ‘on ’))]”,
  “shipments”: [
      {
        “tracking_number”: “xpath[normalize-
space(string(/html/body/table/tr/td/table/tr[2]/td/table/tr[7]/td/div/table/tr[5]/td/table/tr/td[
2]/table/tr[1]/td/table/tr/td[3]/table/tr[3]))]”,
        “tracking_url”: “”,
        “eta_before”: “”,
        “carrier”: “xpath[normalize-space(substring-before(substring-after(normalize-
space(/html/body/table/tr/td/table/tr[2]/td/table/tr[7]/td/div/table/tr[5]/td/table/tr/td[2]/tabl
e/tr[1]/td/table/tr/td[3]/table/tr[1]/td/text( )), ‘Canada ’), ‘ tracking’))]”
      }
  ],
  “items”: {
      “root”:
“/table[tr[2]/td/table/tr/td[2]/table/tr[3]/td/table/tr/td[3]/table/tr[1]/td/b][tr[2]/td/table/tr/td[2
]/table/tr[3]/td/table/tr/td[3]/table/tr[2]/td/table/tr[1]/td[2]/img/@src][tr[2]/td/table/tr/td[2]/t
able/tr[3]/td/table/tr/td[3]/table/tr[2]/td/table/tr[4]/td[3]/table/tr/td[1]][tr[9]/td/table/tr/td[2]/t
able/tr[5]/td/table/tr[1]/td[2]”,
      “start_index”: null,
      “interval”: null,
      “title”: “xpath[normalize-
space(.//tr[2]/td/table/tr/td[2]/table/tr[3]/td/table/tr/td[3]/table/tr[1]/td/b/text( ))]”,
      “quantity”: “xpath[normalize-
space(.//tr[2]/td/table/tr/td[2]/table/tr[3]/td/table/tr/td[3]/table/tr[2]/td/table/tr[4]/td[3]/table
/tr/td[1]/text( ))]”,
      “amount”: “xpath[normalize-
space(.//tr[9]/td/table/tr/td[2]/table/tr[5]/td/table/tr[1]/td[2]/text( ))]”,
      “image_url”:
“xpath[.//tr[2]/td/table/tr/td[2]/table/tr[3]/td/table/tr/td[3]/table/tr[2]/td/table/tr[1]/td[2]/img/
@src]”,
      “url”: null
  }
}
```

Once the parser is generated, in some embodiments the process may proceed to block 830 to extract information from the message using the new parser. However, in practice this information may be available from the LLM response, and the new parser may be used on subsequent messages having similar message template.

Therefore, based on FIG. 8, the embodiments of the present disclosure may use LLMs to create parsers when a particular email or cluster of emails does not have a parser available.

### Validation of Existing Parser

In some embodiments, rather than, or in addition to, the creation of new parsers, the techniques described above could be also used for validating existing parsers.

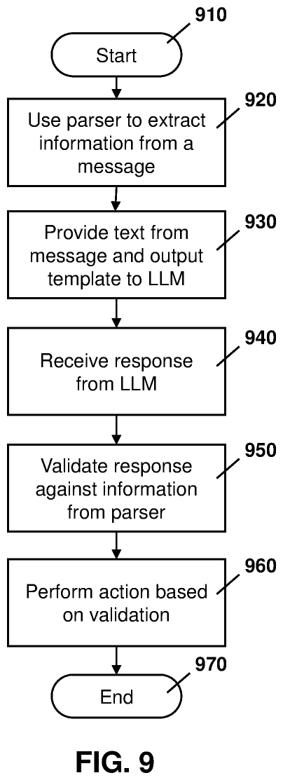

In particular, reference is now made to FIG. 9. The process of FIG. 9 starts at block 910 and proceeds to block 920 in which an existing parser may be used to extract information from a message.

However, in some cases, the information that is extracted from a parser may need to be validated periodically. This may be to ensure that the information being provided from the parser is still accurate. Therefore, the process may further proceed to block 930 in which the text from the message and an output template are provided to an LLM, similar to what was done at block 842 in the embodiment of FIG. 8.

The response may be received from the LLM at block 940 and the process may then proceed to block 950. At block 950, the response from the LLM may be compared to the results from the parser found at block 920.

The process then proceeds to block 960 in which an action may be performed based on the validation on block 950. In particular, if the results from the parser match the result of the LLM, then no action may need to be taken at block 960.

However, if the results do not match, various actions may be taken at the computing device. For example, a new parser may be created using the process of FIG. 8 and the new parser may be substituted for the parser that is currently being used.

In another embodiment, a flag may be raised that may be reviewed by someone at to the platform.

In some cases, the process of FIG. 9 may be performed on other messages within the cluster to ensure that the results of the validation at block 950 were accurate.

Other options are possible.

In this way, an LLM could be used to validate existing parsers within a system.

The above-discussed methods are computer-implemented methods and require a computer for their implementation/use. Such computer system could be implemented on any type of, or combination of, network elements or computing devices, and may for example use the computing device of FIG. 2.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A method at a computing system, the method comprising:
receiving a first message at the computing system;
determining that a parser for the first message does not exist at the computing system;
providing text from the first message and an output template to a large language model;
receiving a response from the large language model, the response comprising the output template populated with information from the message; and
generating a parser for the message based on the response.

2. The method of claim 1, wherein the text contains the information in an unstructured format.

3. The method of claim 2, wherein the response contains the information in a structured format.

4. The method of claim 3, wherein the structured format conforms to the rules of a markup language.

5. The method of claim 1, further comprising, prior to creating the parser, validating the response against the first message.

6. The method of claim 5, wherein the validating comprises checking values received in the response against the first message.

7. The method of claim 1, further comprising:
applying a mapping function to the received message to create a characteristic value, wherein the mapping function is adapted to map similar messages to similar characteristic values; and
grouping the first message with other messages having the similar characteristic values;
wherein the determining further comprises finding that the first message has been grouped with a threshold number of other messages.

8. The method of claim 7, wherein the first message comprises a message within an electronic commerce system, and wherein the information comprises at least one of a tracking identifier, an order date, a ship date, a carrier, and a product information.

9. The method of claim 1, wherein the generating the new parser comprises determining XPATHs in the received message for the information in the response from the large language model.

10. The method of claim 1, wherein the generated parser is used to extract information from a subsequent message having a message template that is similar to a message template for the first message.

11. A computer system comprising:
a processor; and
a communications subsystem,
wherein the computer system is configured to:
receive a first message at the computing system;
determine that a parser for the first message does not exist at the computing system;
provide text from the first message and an output template to a large language model;
receive a response from the large language model, the response comprising the output template populated with information from the message; and
generate a parser for the message based on the response.

12. The computer system of claim 11, wherein the text contains the information in an unstructured format.

13. The computer system of claim 12, wherein the response contains the information in a structured format.

14. The computer system of claim 13, wherein the structured format conforms to the rules of a markup language.

15. The computer system of claim 11, wherein the computer system is further configured to, prior to creating the parser, validate the response against the first message.

16. The computer system of claim 15, wherein the computer system is configured to validate by checking values received in the response against the first message.

17. The computer system of claim 11, wherein the computer system is further configured to:
apply a mapping function to the received message to create a characteristic value, wherein the mapping function is adapted to map similar messages to similar characteristic values; and
group the first message with other messages having the similar characteristic values;
wherein the computer system is configured to determine by finding that the first message has been grouped with a threshold number of other messages.

18. The computer system of claim 17, wherein the first message comprises a message within an electronic commerce system, and wherein the information comprises at least one of a tracking identifier, an order date, a ship date, a carrier, and a product information.

19. The computer system of claim 11, wherein the computer system is configured to generate the new parser comprises determining XPATHs in the received message for the information in the response from the large language model.

20. The computer system of claim 11, wherein the generated parser is used to extract information from a subsequent message having a message template that is similar to a message template for the first message.

21. A non-transitory computer readable medium for storing instruction code, which, when executed by a processor of a computer system cause the computer system to:
receive a first message at the computing system;
determine that a parser for the first message does not exist at the computing system;
provide text from the first message and an output template to a large language model;
receive a response from the large language model, the response comprising the output template populated with information from the message; and
generate a parser for the message based on the response.
